(19) United States
(12) Patent Application Publication
(10) Pub. No.: US 2016/0312494 A1
(43) Pub. Date: Oct. 27, 2016

(54) COMMON LOCKING DEVICE FOR NON-DRIVING PART OF WORK VEHICLE

(71) Applicant: VOLVO CONSTRUCTION EQUIPMENT AB, Eskilstuna (SE)

(72) Inventors: Young-Il Kim, Gyeongsangnam-do (KR); Han-Choul Shin, Gyeongsangnam-do (KR); Min-Sung Kim, Gyeonggi-do (KR); Guk-Geon Lim, Gyeongsangnam-do (KR)

(73) Assignee: VOLVO CONSTRUCTION EQUIPMENT AB, Eskilstuna (SE)

(21) Appl. No.: 15/103,717

(22) PCT Filed: Dec. 11, 2013
(86) PCT No.: PCT/KR2013/011478

§ 371 Date: Jun. 10, 2016

(51) Int. Cl. E05B 29/00; E05B 19/00; E05B 85/06

(52) U.S. Cl. CPC E05B 29/0033; E05B 85/06; E05B 29/0046; E05B 19/0058

(57) ABSTRACT

A locking device is disclosed. It includes a cylindrical common rotor having a guide for guiding key insertion into a key insertion hole. The locking device also includes disc-shaped tumblers. The present invention solves the problem of inconvenience in carrying several individual keys for unlocking the driving part and the non-driving part of the work vehicle. Also, it is possible to effectively maintain the non-driving part of the work vehicle so that the work vehicle can be systematically managed, thereby improving the quality of maintenance service.

### TECHNICAL FIELD

The present disclosure relates to a locking device for a working vehicle. More particularly, the present disclosure relates to a common locking device for a non-driving part of a working vehicle, the common locking device allowing common keys to be provided to workers concerned with non-driving parts of a vehicle such that the workers can lock and unlock non-driving parts of a plurality of working vehicles while allowing a driving part of a specific vehicle to be locked and unlocked using a individual key configured to lock and unlock a driving part of the specific vehicle.

### BACKGROUND ART

In general, working vehicles include excavators and loaders used in construction or civil engineering sites to load, excavate, or dump earth, sand and the like, as well as vehicles, such as cranes and forklifts, used in the operation of moving or loading heavy objects.

Conventional working vehicles must be provided with locking devices to prevent the loss of vehicles in addition to theft from the interiors of vehicle cabs or from major storage boxes and to restrict vehicle operations by non-approved operators.

In particular, when a single operator operates a plurality of working vehicles, separate locking devices are disposed on pieces of equipment, such on a machinery compartment, an engine compartment, and so on, which are not associated with driving and are commonly used for the maintenance of working vehicles (hereinafter referred to as “non-driving parts”) as well as on pieces of equipment, such as a cab door, a vehicle ignition, a fuel tank, and so on, associated with driving (hereinafter referred to as “driving parts”), and individual keys are used to lock and unlock the driving parts and the non-driving parts.

An individual key allocated to a specific working vehicle may be configured to lock and unlock both driving parts and non-driving parts of the working vehicle but may not be able to lock or unlock the driving parts and non-driving parts of other working vehicles.

Thus, when a plurality of working vehicles are provided on a work site, a plurality of individual keys allocated to corresponding working vehicles are respectively carried. It is possible to repair or operate the working vehicles by locking or unlocking the locking devices using the corresponding individual keys.

However, in the case of working vehicles used in construction and civil engineering sites, maintenance services are commonly performed based on on-site after service (A/S). When it is difficult to perform such on-site A/S, a mechanic is sent to a site to repair working vehicles.

Thus, when a plurality of working vehicles possessed by a single operator are to be repaired, the maintenance personnel may suffer from the inconvenience of having to carry a number of keys allocated to individual vehicles to repair or perform routine maintenance on the vehicles.

For example, most working vehicles are basically provided with individual keys, and respective individual keys can be used to lock and unlock the locking device of the driving part as well as the locking device of the non-driving part.

Conventionally, a copy of the individual key is provided to a worker concerned with the non-driving part to access the non-driving part, since both the driving part and the non-driving part are locked and unlocked using the individual key.

In this case, the worker concerned with the non-driving part may gain entry to the driving part without permission, which is problematic. In addition, security management of individual keys may not be properly performed. For example, a copy of an individual key may be lost, causing the working vehicle itself or valuable objects locked in the cab to be stolen.

In addition, when an individual key is not copied, the worker concerned with the non-driving part cannot perform related operations thereon unless the owner having the individual key is present. This causes operations to be complicated and inefficient.

In particular, vehicle manufacturer representatives responsible for A/S cannot repair vehicles without taking possession of the keys from the owner of the vehicles or unless the owner is present.

In addition, the manufacturers of working vehicles provide various types of conventional locking devices used in driving parts and non-driving parts of working vehicles.

For example, a prior-art working vehicle is disclosed in Korean Registered Utility Model No. 20-0212575, titled “KEY CYLINDER ASSEMBLY OF VEHICLE DOOR LOCK.”

The above-mentioned prior art document is directed towards improving the configuration of a key cylinder of a door lock attached to a door of a vehicle to prevent the vehicle from theft, so that the door is prevented from being opened from the outside without permission. A configuration for further restricting opening and unlocking is added to the door lock having a typical tumbler array to fundamentally prevent a third party from easily opening the door using a piece of steel wire or on the like.

However, most conventional locking devices including the above-mentioned prior art used in working vehicles are intended to maximize security to prevent a third party from breaking into the driving parts and non-driving parts.

To date, no devices allowing locking devices to be commonly used in the non-driving parts of working vehicles have been provided, and no prior-art approaches related thereto have been disclosed.

Consequently, there is a need to realize a common locking device and a common key for the non-driving parts of a plurality of working vehicles as described above. In this regard, the locking device and the common key are required to allow the non-driving parts of vehicles to be commonly locked and unlocked by the same group of users concerned with the non-driving parts while allowing security for preventing a third party from breaking into the cabs of the vehicles to be maintained.

### DISCLOSURE

### Technical Problem

Accordingly, the present disclosure has been made keeping the above problems occurring in the related art in consideration, and the present disclosure is intended to propose a common locking device for a non-driving part of a working vehicle. The common locking device allows a worker approved for access to non-driving parts, such as a mechanic, to lock and unlock non-driving parts of a plurality of working vehicles without individual keys while allowing security for preventing a third party from breaking into the non-driving part of a working vehicle to be maintained.

In addition, the present disclosure is intended to provide a common locking device for a non-driving part of a working vehicle. The common locking device used in a non-driving part of a working vehicle can maintain the common use and security function thereof while maximizing assembly efficiency and mass production by simplifying the configuration of a tumbler array.

The above and other objects will be more fully apparent to a person skilled in the art from the following description.

### Technical Solution

According to an aspect of the present disclosure, a common locking device may include: keys respectively including projections and depressions, the keys including common keys to be commonly used by persons concerned with a non-driving part of a working vehicle not associated with driving of the working vehicle to lock or unlock the non-driving part; a fixed housing disposed in the non-driving part of the working vehicle, and having a rotation space defined therein, in an inner circumference of which a plurality of blocking grooves are formed and arranged; a cylindrical common rotor rotatably disposed in the rotation space, and having a plurality of disk slots cut through outer surfaces thereof in directions intersecting a direction in which the key is inserted and a pair of guide protrusions formed on inner wall portions of an entrance of an inner key-hole to guide insertion of the key; and disk-shaped tumblers fitted into the disk slots to be elastically pushed in directions of the blocking grooves, wherein each of the disk-shaped tumblers includes: a key channel formed in a central portion to have an opening on one side; a connecting portion on the opposite side forming an arc-shaped engagement portion, a radius of which is smaller than an inner radius of the rotation space; and a pair of disengagement protrusions on inner circumferential portions of the opening to face each other, wherein the projections and the depressions of the key are to come into contact with the disengagement protrusions. Ends of the engagement portions are formed differently from each other to engage with the blocking grooves to such slight depths that the engagement portions can be disengaged from the blocking grooves by an outermost projection from among the projections, an innermost projection from among the projections and the depressions, allowing the common rotor to be unlocked using the common keys.

In addition, the key may include individual keys respectively configured to lock and unlock both a driving part and a non-driving part of a specific working vehicle and the common keys respectively configured to lock and unlock non-driving parts of a plurality of working vehicles. Each of the individual keys and the common keys may include a pair of insertion guide grooves in both side surfaces of a flat blade, the insertion guide grooves configured to receive the guide protrusions to guide insertion of the key. The projections and depressions may be formed below the insertion guide groove in one side surface of the blade and above the insertion guide groove in the other side surface of the blade, and in response to the blade being inserted, come into contact with the disengagement protrusions to move the tumblers, so that the engagement portions are separated from the blocking grooves, thereby allowing an unlocked position to be obtained.

The insertion guide grooves of each of the individual keys and the common keys may include a first guide groove formed in one side surface of the blade to be offset downwardly from a centerline and a second guide groove formed in the other side surface of the blade to be offset upwardly from the centerline, such that the second guide groove is offset with respect to the first guide groove. The guide protrusions of the common rotor may include a first protrusion and a second protrusion formed in positions corresponding to the first guide groove and the second guide groove to restrict insertion of the other keys, except for the individual keys configured to lock and unlock the driving parts of the working vehicles and the common keys in which the first guide groove and the second guide groove are commonly formed.

The insertion guide grooves and the guide protrusions may be diagonally offset with respect to a central axis of a portion into which the common keys are inserted while maintaining equal distances therefrom, such that, when the individual keys and the common keys are inserted into the key-hole, directions in which the keys are inserted are not restricted.

One disk slot from among the plurality of disk slots may include a blocking slot. A fastening groove may be formed in an inner circumference of the fixed housing to be parallel to the blocking grooves. A blocking tumbler may be disposed in the blocking slot, the blocking tumbler being elastically fitted into the fastening groove to prevent the common rotor from being separated.

The blocking tumbler may have the same shape as the disk-shaped tumblers, with a matching recess being formed in a central position of an arc-shaped engagement portion of the blocking tumbler. The fastening groove may be formed in an inner circumference of the rotation space to extend around the inner circumference. A matching protrusion may be disposed on an inner circumference of the fastening groove, the matching recess being fitted on the matching protrusion to set the common rotor in a predetermined position when the common rotor is attached to the fixed housing.

A shoulder may be disposed on one side of the arc-shaped engagement portion of each of the disk-shaped tumblers and the blocking tumbler to be supported on top of a coil spring. Seating recesses may be formed on both sides of each of the disk slots, the coil springs being disposed in the seating recesses, such that the shoulder is movable through a passage formed in a portion connecting the seating recesses.

The disk-shaped tumblers may be a pair of disk-shaped tumblers overlapping each other such that the shoulders face in opposite directions, the pair of overlapped disk-shaped tumblers being fitted into the disk slots such that the shoulders are supported on the coil springs, respectively. The blocking tumbler may be a single blocking tumbler fitted into the blocking slot to be supported on the coil spring disposed in the seating recess on one side.

### Advantageous Effects

According to the common locking device for a non-driving part of a working vehicle according to the present disclosure, when a plurality of working vehicles are operated, it is possible to repair and manage the plurality of working vehicles by efficiently managing the operations of locking and unlocking non-driving parts using common keys and common locking devices. It is therefore possible to overcome the problem of inconvenience in that several keys must be individually carried to unlock driving parts and non-driving parts of working vehicles.

In addition, it is possible to efficiently divide and manage operators in charge of operating working vehicles and mechanics concerned with the maintenance of working vehicles, thereby effectively preventing working vehicles from being stolen.

Furthermore, manufacturers of working vehicles can more efficiently and systematically manage the maintenance of non-driving parts, thereby improving the quality of maintenance services.

In addition, according to the present disclosure, it is possible to improve the assembly efficiency and mass production of common locking devices by simplifying the configuration of the tumbler array thereof. It is also possible to realize the common use of the locking devices for non-driving parts while maintaining the security of the locking devices.

### DESCRIPTION OF DRAWINGS

FIG. 1 is a block diagram illustrating a common locking device used in a non-driving part of a working vehicle according to the present disclosure;

FIG. 2 is an exploded perspective view illustrating the configuration of a common rotor and a common key of the common locking device for a non-driving part of a working vehicle according to the present disclosure;

FIG. 3 is elevation views illustrating the configuration of the common key according to the present disclosure;

FIG. 4 is a front elevation view illustrating the configuration of the tumbler according to the present disclosure;

FIG. 5a and FIG. 5b are side and vertical cross-sectional views illustrating the common locking device according to the present disclosure before the common key is fitted thereinto;

FIG. 6a and FIG. 6b are side and vertical cross-sectional views illustrating the common locking device according to the present disclosure into which the common key is fitted;

FIG. 7 is a vertical cross-sectional views illustrating an unlocked position in which the common rotor is rotated by the common key according to the present disclosure; and

FIG. 8 is a vertical cross-sectional view illustrating an assembled position in which the blocking tumbler according to the present disclosure is attached to the fixing housing.

### DESCRIPTION OF THE REFERENCE NUMERALS IN THE DRAWINGS

| | |
|---|---|
| 1: WORKING VEHICLE | 2: DRIVING PART |
| 3: NON-DRIVING PART | 4: INDIVIDUAL LOCKING |
| | DEVICE |
| 5: INDIVIDUAL KEY | 10: SECOND WORKING |
| | VEHICLE |
| 12: SECOND DRIVING PART | 13: SECOND NON-DRIVING |
| | PART |
| 14: SECOND INDIVIDUAL | 15: SECOND INDIVIDUAL KEY |
| LOCKING DEVICE | |
| 20: FIXED HOUSING | 21: BLOCKING GROOVE |
| 22: ROTATION SPACE | 23: MATCHING PROTRUSION |
| 24: FASTENING GROOVE | 25: DISENGAGEMENT RECESS |
| 30: COMMON ROTOR | 31: DISK SLOT |
| 32: KEY-HOLE | 33: GUIDE PROTRUSION |
| 33A: FIRST PROTRUSION | 33B: SECOND PROTRUSION |
| 34: BLOCKING SLOT | 35: SEATING RECESS |
| 36: PASSAGE | 37: ROD |
| 40: DISK-SHAPED TUMBLER | 41: KEY CHANNEL |
| 42: ENGAGEMENT PORTION | 43: DISENGAGEMENT |
| | PROTRUSION |
| 43A: CHAMFERED PORTION | 44: BLOCKING TUMBLER |
| 44A: MATCHING RECESS | 45: SHOULDER |
| 50: COIL SPRING | |
| 60: CLOSING CAP | 60A: KEY-HOLE |
| 61: SHUTTER | 62: TORSION SPRING |
| 70: LOCKING LEVER | |
| 100: COMMON LOCKING DEVICE | |
| 200: COMMON KEY | 201: BLADE |
| 202: INSERTION GUIDE GROOVE | 202A: FIRST GUIDE GROOVE |
| 202B: SECOND GUIDE GROOVE | 203: PROJECTION |
| 203A: OUTER PROJECTION | 203B: INNER PROJECTION |
| 204: DEPRESSION | 205: BOW |
| C: CENTER OF (BLADE) | |

### MODE FOR INVENTION

Hereinafter, reference will be made in detail to a locking system for a working vehicle according to the present disclosure in conjunction with the accompanying drawings.

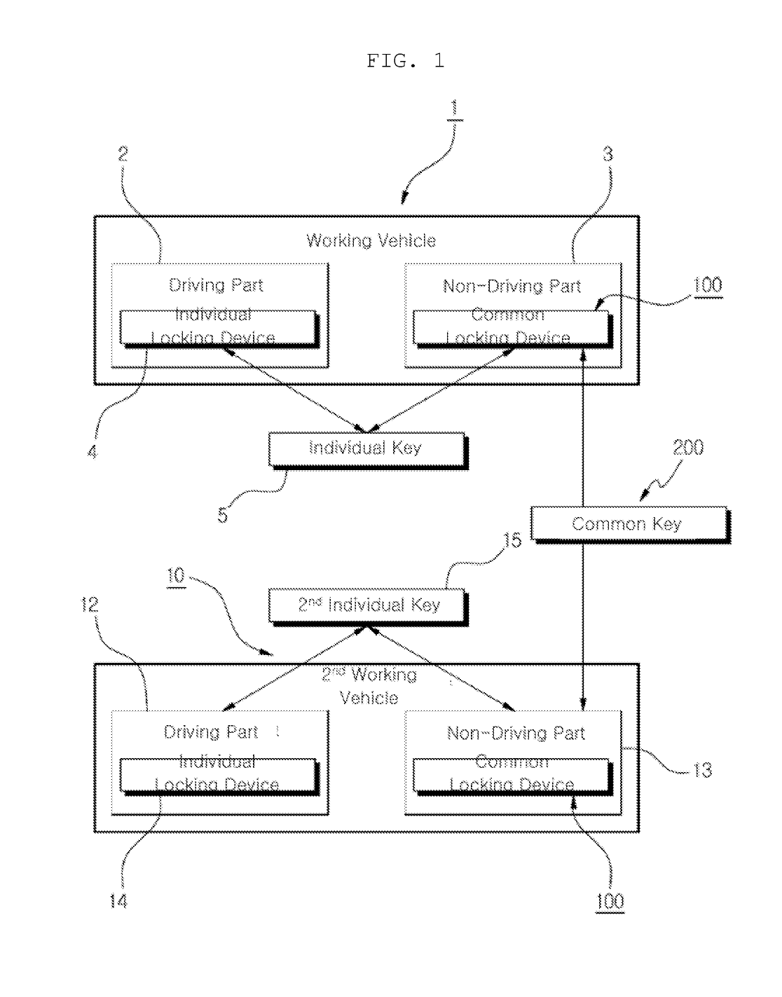

FIG. 1 is a block diagram illustrating a common locking device used in a non-driving part of a working vehicle according to the present disclosure.

In general, as illustrated in FIG. 1, a working vehicle 1 is divided into a driving part 2 associated with driving of the working vehicle 1 and a non-driving part 3 not associated with driving of the working vehicle 1.

Thus, the present disclosure has common locking devices 100 disposed on non-driving parts 3 and 13 of a plurality of working vehicles including a second working vehicle 10 such that approved workers can conveniently lock and unlock the non-driving parts 3 and 13 using a common key 200 according to the present disclosure while allowing locking and unlocking driving parts 2 and 12 and the non-driving parts 3 and 13 using individual keys 5 and 15.

In the description of the present embodiment, the driving parts 2 and 12 are associated with the driving of the working vehicles 1 and 10, and indicate cabs (not shown), or compartments in which operators can sit and operate the working vehicles 1 and 10. The driving parts 2 and 12 include vehicle ignitions (not shown) for turning the working vehicles 1 and 10 on and off and unlocking and locking fuel tanks (not shown) for refilling the fuel tanks with fuel for the operation of the working vehicles 1 and 10.

In addition, the non-driving parts 3 and 13 are parts excepting the parts associated with the operation of the working vehicles 1 and 10, and indicate engine compartments (not shown) for generating power. The non-driving parts 3 and 13 include machinery compartments (not shown) in which parts or tools are accommodated and maintenance compartments (not shown) for repairs to engines or the like.

In the working vehicles 1 and 10 including the driving parts 2 and 12 associated with driving and the non-driving parts 3 and 13 not associated with driving, conventional individual locking devices 4 and 14 are used in the driving parts 2 and 12, while the common locking devices 100 according to the present embodiment as described above are used in the non-driving parts 3 and 13 of the working vehicles 1 and 10.

In addition, the working vehicles 1 and 10 are basically provided with the individual keys 5 and 15 to lock and unlock the individual locking devices 4 and 14 and the common locking devices 100. The individual key 5 needs to be configured such that the individual key 5 can only lock and unlock the non-driving part 3 of the working vehicle 1 but can neither lock nor unlock the non-driving part 13 of the second working vehicle 10.

Thus, the present disclosure further includes the common key 200 to lock and unlock the common locking devices 100 used in non-driving parts of a plurality of working vehicles, including the non-driving part 3 of the working vehicle 1 and the non-driving part 13 of the second working vehicle 10.

The configuration of the common key 200 is similar to those of the individual keys 5 and 15. The individual keys 5 and are configured to lock and unlock both the common locking device 100 and the individual locking devices 4 and 14 respectively. The common key 200 is configured to lock and unlock the common locking devices 100 of the plurality of working vehicles 1 and 10.

Here, the driving parts 2 and 12 of the working vehicles 1 and 10 can be locked using the individual keys 5 and 15 and the individual locking devices 4 and 14 configured to lock and unlock cab doors (not shown), vehicle ignitions (not shown), and fuel tank parts (not shown).

In addition, the non-driving parts 3 and 13 can be locked using the common key 200 and the common locking devices 100 configured to lock and unlock power compartments, engine compartments, machinery compartments, and maintenance compartments.

As described above, the present disclosure is devised to provide the common key 200 to commonly lock and unlock the non-driving parts 3 and 13 of the plurality of working vehicles 1 and 10 while providing the respective working vehicles 1 with the individual keys 5 and 15 configured to lock and unlock the respective driving parts 2 and 12 and the respective non-driving parts 3 and 13.

Thus, operators can unlock the cab doors (not shown) using the individual keys 5 and 15 to operate the working vehicles 1 and 10 respectively. Afterwards, the operators start the vehicle ignitions using the individual keys 5 and 15, thereby operating the working vehicles 1 and 10 respectively.

According to the present disclosure, since the individual locking device 4 is used only for the driving part 2, it is impossible to lock or unlock the individual locking device of the driving part 2 using any other keys, such as the individual key 15 for the second working vehicle 10 or the common key 200, except for the individual key 5.

In addition, since the common locking devices 100 according to the present disclosure are used in the non-driving parts 3 and 13 of the plurality of working vehicles 1 and 10, it is possible to lock and unlock all of the common locking devices 100 according to the present disclosure for the non-driving parts 3 and 13 of the plurality of working vehicles 1 and 10 using the common key 200 provided separately from the individual keys 5 and 15.

Since authorized workers can lock and unlock, for example, the engine compartments for generating power, the machinery compartments in which a plurality of parts or tools are accommodated, the maintenance compartments for repairs to engines or the like, or so on, maintenance can be rapidly performed, and the parts, the tools, and so on accommodated in the machinery compartments can be taken out and used on-site.

Accordingly, a mechanic, an on-site operator, and so on authorized for maintenance can be given the common key 200, so that the mechanic, the on-site worker, or so on can lock and unlock the common locking devices 100 of the non-driving parts 3 and 13. In this manner, even when an owner or an operator possessing the individual key is absent, a maintenance operation or the like can be performed.

According to the present disclosure as described above, it is possible to lock and unlock the common locking devices 100 of the plurality of working vehicles 1 and 10 using the common key 200, thereby removing the problem that several keys for the driving parts 2 and 12 and the non-driving parts 3 and 13 must be individually carried.

In addition, even when operators are absent or possess no individual keys 5 and 15, a maintenance services can be performed for the non-driving parts 3 and 13. This advantageously allows the working vehicles to be efficiently managed in construction sites.

The configuration of the common locking device according to the present disclosure for an efficient management for non-driving parts of a plurality of working vehicles will be described in greater detail as follows.

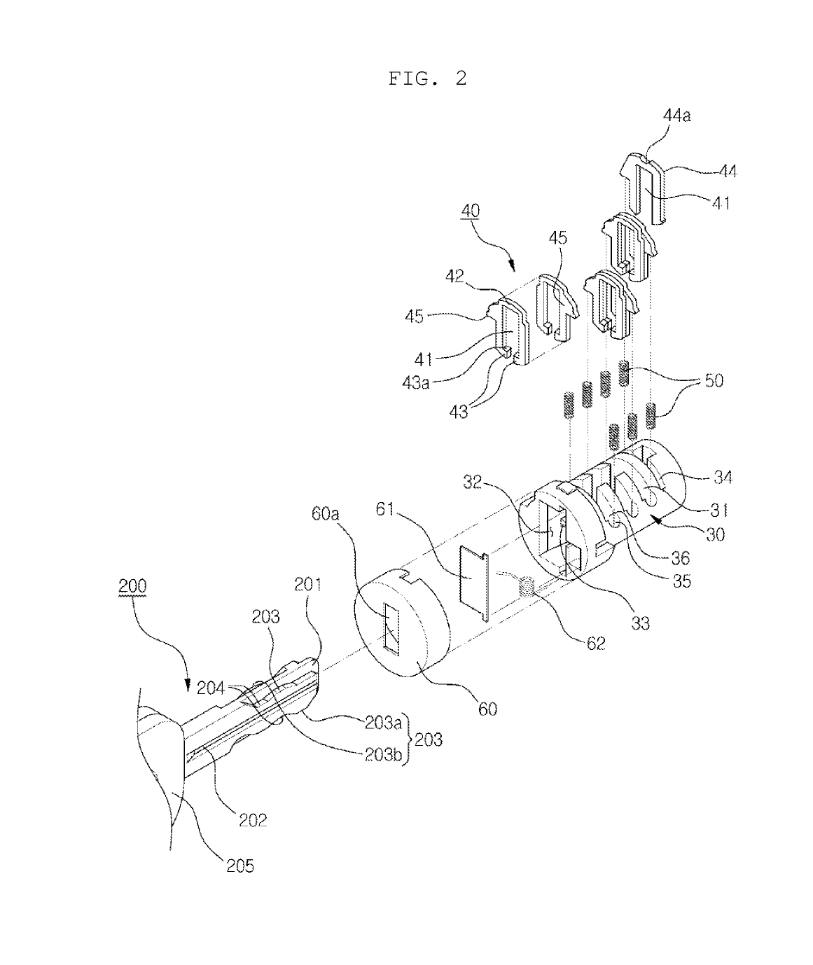

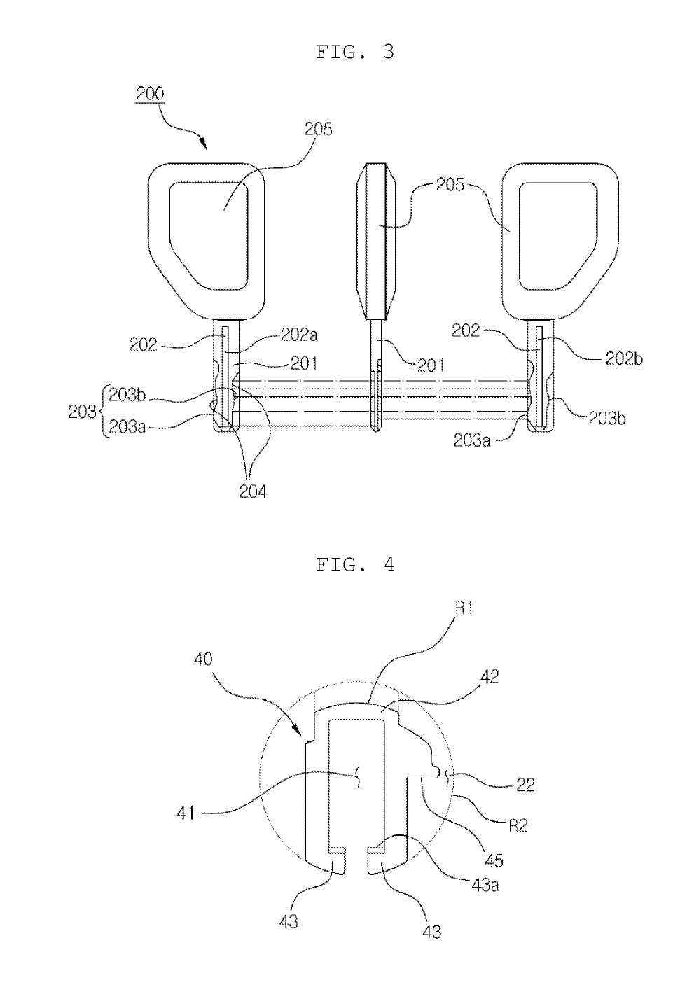

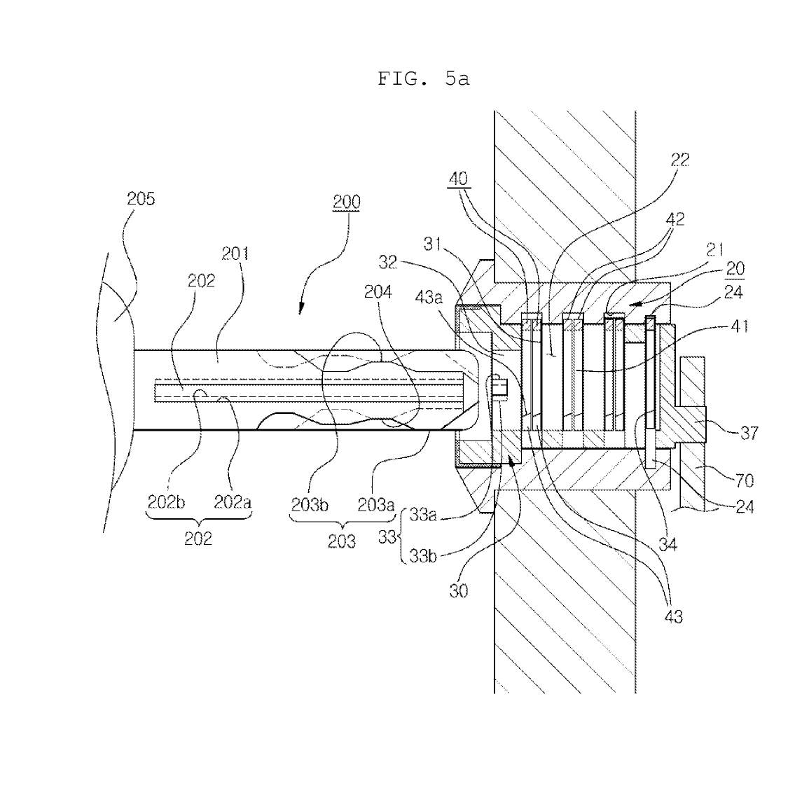

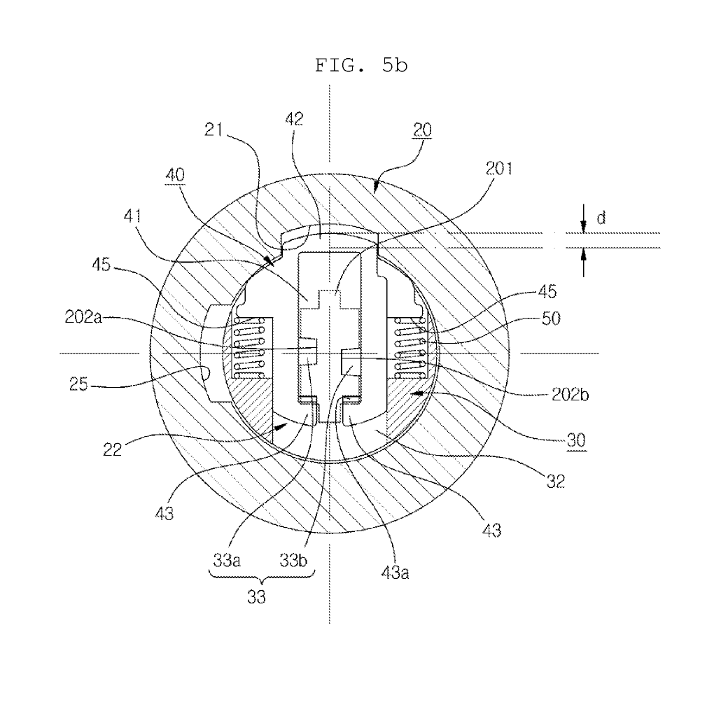

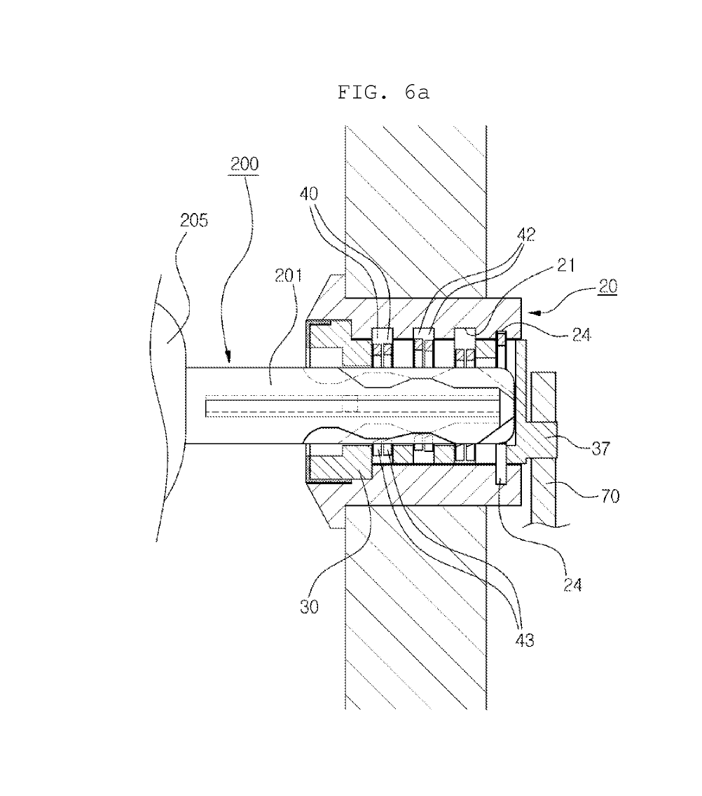

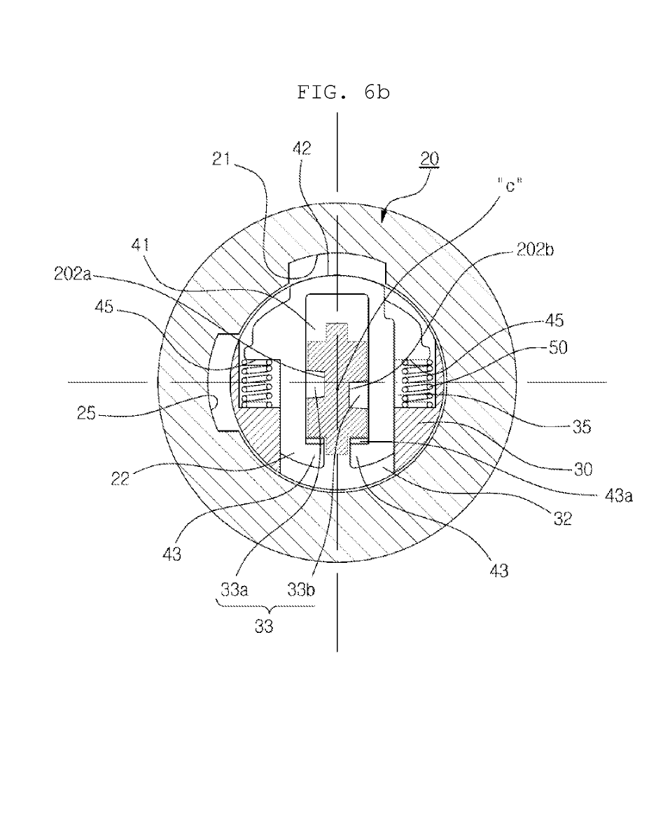

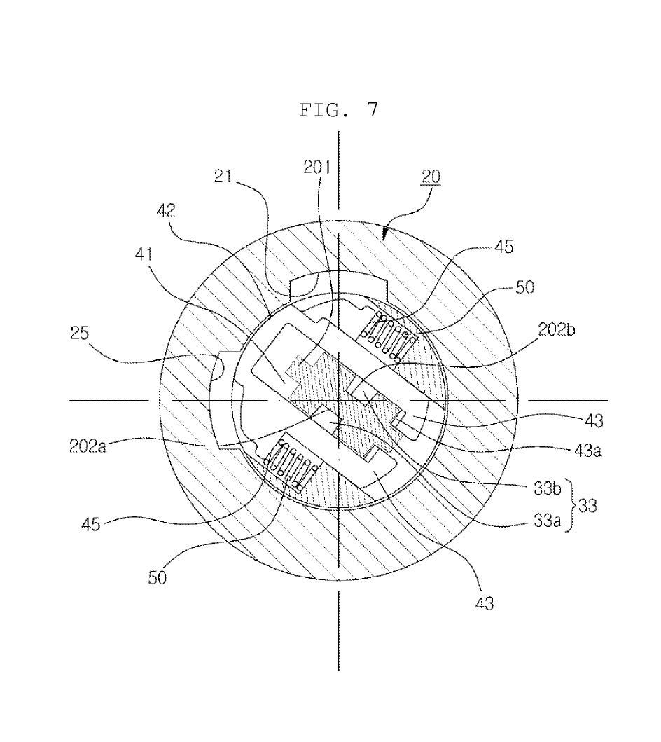

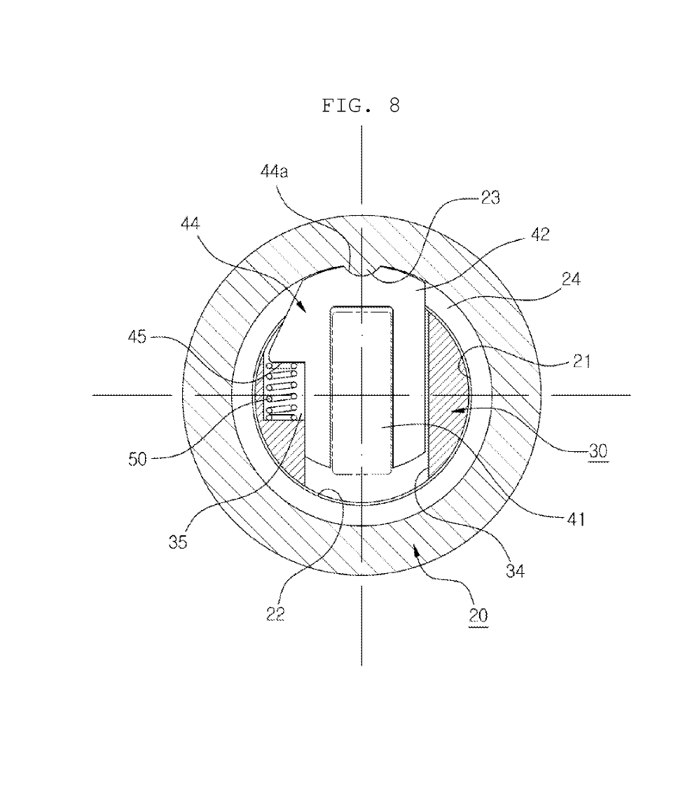

FIG. 2 is an exploded perspective view illustrating the configuration of a common rotor and a common key of the common locking device for a non-driving part of a working vehicle according to the present disclosure, FIG. 3 is elevation views illustrating the configuration of the common key according to the present disclosure, FIG. 4 is a front elevation view illustrating the configuration of a tumbler according to the present disclosure, FIG. 5a and FIG. 5b are side cross-sectional and vertical cross-sectional views illustrating the common locking device according to the present disclosure before the common key is fitted thereinto, FIG. 6a and FIG. 6b are side cross-sectional and vertical cross-sectional views illustrating the common locking device according to the present disclosure into which the common key is fitted, FIG. 7 is a vertical cross-sectional view illustrating an unlocked position in which the common rotor can be rotated by the common key according to the present disclosure, and FIG. 8 is a vertical cross-sectional view illustrating the common locking device according to the present disclosure wherein the blocking tumbler according to the present disclosure is attached to the fixing housing.

The present disclosure provides a cylindrical locking device with the common key 200 having projections 203 and depressions 204 such that the locking device can be commonly managed by workers authorized for handling of the non-driving parts 3 and 13 to lock or unlock the non-driving parts 3 and 13 that are not associated with driving of the working vehicles 1 and 10.

Specifically, the locking device includes a cylindrical fixed housing 20, a cylindrical common rotor 30, and disk-shaped tumblers 40.

The fixed housing 20 has a rotation space 22 defined therein, in which the common rotor 30 is rotatably installed.

A plurality of blocking grooves 21 are formed in the inner circumference of the fixed housing 20 and are arranged in the longitudinal direction, with the number thereof being equal to that of the disk-shaped tumblers 40.

That is, the blocking grooves 21 are configured to engage with and lock predetermined ends of the disk-shaped tumblers 40, and are arranged at suitable distances from each other in the direction in which the common key 200 is inserted.

In addition, the cylindrical common rotor 30 is disposed to be rotatable without being separated from the rotation space 22.

The common rotor 30 has a plurality of disk slots 31 cut therethrough. The disk slots 31 are formed in positions corresponding to the blocking grooves 21 and in directions crossing the direction in which the key is inserted when the common rotor 30 is accommodated in the rotation space 22. The disk slots 31 are arranged in a line in the direction in which the key is inserted.

The widths of the disk slots 31 are formed to be slightly greater than the thicknesses of the disk-shaped tumblers 40, such that the disk-shaped tumblers 40 move up and down smoothly through contact with the projections 203 and the depressions 204 when the key is inserted.

The common rotor 30 has a key-hole 32 defined therein, extending in the longitudinal direction. According to the present embodiment, the key-hole 32 has an oblong cross-sectional shape, such that the flat common key 200 can be inserted into the key-hole 32.

A pair of guide protrusions 33 are formed on the inner wall surface of the entrance of the key-hole 32 to guide the insertion of the common key 200.

The guide protrusions 33 may have a semicircular or oblong cross-sectional shape. Insertion guide grooves 202 of the common key 200 to be described later are shaped to conform to the cross-sectional shape of the guide protrusions 33.

The disk-shaped tumblers 40 are metal plates, the thicknesses of which are smaller than the widths of the disk slots 31, with the opposite side portions thereof being straight and parallel to each other. The top and bottom portions have the shape of arcs conforming to the circumference of the rotation space 22, with the bottom ends being opened at a width that allows the key to be inserted therethrough.

In addition, a shoulder 45 is formed on one side portion of each of the tumblers. In a position in which the tumblers are fitted into the corresponding disk slot 31, the shoulders 45 are supported on coil springs 50 such that the shoulders 45 are elastically pushed toward the blocking grooves 21.

Thus, in the position in which the disk-shaped tumblers 40 are fitted into the disk slot 31, the disk-shaped tumblers 40 are elastically pushed toward the blocking grooves 21 of the fixed housing 20 by the coil springs 50 so that the disk-shaped tumblers 40 are engaged with the blocking grooves 21, thereby forming a locked position. When the disk-shaped tumblers 40 move down to be separated from the blocking grooves 21 in response to the manipulation of the key, an unlocked position is obtained.

In addition, key channels 41 opened in one direction are formed in the central portions of the disk-shaped tumblers 40, such that the individual keys 5 and 15 and the common key 200 can be inserted thereinto.

Furthermore, each tumbler has an arc-shaped engagement portion 42, the radius of which is smaller than the radius of the rotation space 22, such that the arc-shaped engagement portion 42 is fitted into the corresponding blocking groove 21. A pair of disengagement protrusions 43 are formed on the inner circumference of the opposite portions to face each other, such that the projections 203 and the depressions 204 of the key come into contact with the pair of disengagement protrusions 43.

Thus, when the common key 200 is inserted, the projections 203 or the depressions 204 of the common key 200 move the disk-shaped tumblers 40 downwardly through coming into contact with the disengagement protrusions 43, so that the engagement portions 42 are separated from the blocking grooves 21, thereby allowing an unlocked position to be obtained.

The present disclosure includes the individual keys 5 and 15 configured to lock and unlock both a driving part and a non-driving part of a working vehicle, and further includes the common key 200 configured to lock and unlock non-driving parts of a plurality of working vehicles.

Each of the individual keys 5 and 15 and the common key 200 has a pair of insertion guide grooves 202 in both side surfaces of a flat blade 201. The insertion guide grooves 202 receive the guide protrusions 33, thereby guiding the insertion of the key.

In addition, the projections 203 and the depressions 204 are formed below an insertion guide groove 202 in one side surface of the blade 201 and above another insertion guide groove 202 in the other side surface of the blade 201. When the blade 201 is inserted, the projections 203 and the depressions 204 come into contact with the disengagement protrusions 43 to move the disk-shaped tumblers 40, so that the engagement portions 42 are separated from the blocking grooves 21, thereby allowing an unlocked position to be obtained.

It is preferable that chamfered portions 43a are formed on the top portions of the disengagement protrusions 43. The chamfered portions 43a guide the projections 203 and the depressions 204 of the common key 200 to reliably come into contact with the disengagement protrusions 43.

Here, as the most characteristic feature of the present disclosure, the engagement portions 42 of the disk-shaped tumblers 40 configured to be fitted into the corresponding blocking groove 21 to lock the locking device are slightly fitted.

That is, as illustrated in FIG. 4, the radii R1 of the arcs of conventional disk-shaped tumblers are formed to correspond to the radius R2 of the rotation space 22 of the fixed housing 20.

Each of the engagement portions 42 of the disk-shaped tumblers 40 according to the present disclosure is configured such that the insertion length thereof is shorter than the insertion length defined by the radii R1 of the engagement portions of the conventional disk-shaped tumblers to match the blocking groove 21.

Thus, the engagement portions 42 can be slightly fitted into the blocking grooves 21. When the common key 200 and the individual keys 5 and 15 are inserted, and then the disk-shaped tumblers 40 are moved slightly downwardly, the engagement portions 42 are separated from the blocking grooves 21, thereby allowing an unlocked position to be obtained.

In this regard, according to the present disclosure, the projections 203 or the depressions 204 of the common key 200 are formed in the same positions as the projections 203 or the depressions 204 of the individual keys 5 and 15. As illustrated in FIG. 5b, ends of the engagement portions 42 are formed to engage with the blocking grooves 21 to such slight depths, without being deeply engaged with the corresponding blocking groove 21, that the engagement portions 42 can be disengaged from the blocking grooves 21 by an outermost projection 203a, an innermost projection 203b and the depressions 204.

Thus, even when the disk-shaped tumblers 40 are moved slightly downwardly by the projections 203 and the depressions 204 of the common key 200 that are manufactured differently, the engagement portions 42 are separated from the blocking grooves 21 so that the common rotor 30 can be unlocked.

Consequently, the individual locking devices 4 and 14, in which engagement portions of disk-shaped tumblers have conventional sizes to engage with the blocking grooves 21 at ordinary depths, can only be locked and unlocked by the individual keys 5 and 15.

In addition, since the common locking device 100 is configured such that the engagement portions 42 of the disk-shaped tumblers 40 are slightly engaged with the blocking groove as described above, the common locking device 100 can be locked and unlocked using both the individual keys 5 and 15 and the common key 200.

Thus, when the common key 200 is inserted into the individual locking devices 4 and 14, the disk-shaped tumblers 40 are moved downwardly by shorter distances than when the individual keys 5 and 15 are inserted, so that the individual locking devices disposed on the driving parts can be neither locked nor unlocked. A worker cannot unlock the driving parts using the common key 200 and thus cannot operate the driving parts.

Here, reference numeral 60 indicates a closing cap having a key-hole 60a communicating with the key-hole 32 to close the front side of the common rotor 30. Reference numeral 61 indicates a shutter rotatably attached to a front portion of the common rotor to close the key-hole 60a. Reference numeral 62 indicates a torsion spring elastically pushing the shutter forwards to close the key-hole 60a.

The present disclosure is configured such that the insertion guide grooves 202 of the individual keys 5 and 15 and the common key 200 do not restrict the key to have a particular orientation.

For example, the insertion guide grooves 202 include a first guide groove 202a formed in one side surface of the blade 201 to be downwardly offset from the centerline and a second guide groove 202b formed in the other side surface of the blade 201 to be upwardly offset from the centerline, such that the second guide groove 202b is offset from the first guide groove 202a.

The corresponding guide protrusions 33 of the common rotor 30 include a first protrusion 33a and a second protrusion 33b formed in positions corresponding to the first guide groove 202a and the second guide groove 202b respectively.

Thus, this configuration excludes the insertion of other keys except for the individual keys 5 and 15 and the common key 200 in which the same first guide grooves 202a and the same second guide grooves 202b are provided.

This configuration can also provide a security function by setting the insertion guide grooves 202 and the guide protrusions 33 in offset arrangements such that a third party cannot unlock the non-driving parts 3 and 13 of the plurality of working vehicles 1 and 10 using keys other than the individual keys 5 and 15 and the common key 200, a piece of steel wire, and so on, while allowing the common key 200 to be commonly used for the non-driving parts 3 and 13 of the plurality of working vehicles 1 and 10.

In addition, according to the present disclosure, the arrangements of the insertion guide grooves 202 and the guide protrusions 33 are configured such that, when the individual keys 5 and 15 and the common key 200 are inserted into the key-hole 32, each key is not required to have a particular orientation. That is, as illustrated in FIG. 6b, the insertion guide grooves 202 and the guide protrusions 33 are diagonally offset with respect to the center C of the blade of the common key 200 at the same distance from the center C.

This configuration allows the positions of the insertion guide grooves 202 and the guide protrusions 33 to be offset by the same distance from the center C while providing the security function as described above. It is thereby possible to rapidly and conveniently perform locking and unlocking operations without restricting the orientation of each key when the individual keys 5 and 15 and the common key 200 are inserted.

In addition, the present disclosure is configured to provide assembly convenience when attaching the common rotor 30 to the fixed housing 20 and to prevent the common rotor 30 from being forcibly separated after being attached.

That is, as illustrated in FIG. 2 to FIG. 8, one from among the slots forms a blocking slot 34.

In addition, a fastening groove 24 is further formed in the inner circumference of the fixed housing 20 to be parallel to the blocking grooves 21. A blocking tumbler 44 disposed in the blocking slot 34 is further provided. The blocking tumbler 44 is elastically fitted into the fastening groove 24 to prevent the common rotor 30 from being separated.

It is preferable that the blocking tumbler 44 have the same shape as the disk-shaped tumblers 40 to improve the efficiency of attaching the blocking tumbler 44 and the disk-shaped tumblers 40 to the common rotor.

In addition, an alignment recess 44a is formed in the central position of the arc-shaped engagement portion 42 of the blocking tumbler 44. The fastening groove 24 is formed along the entire circumference of the rotation space 22.

Thus, an alignment protrusion 23 is formed on the inner circumference of the fastening groove 24. When the common rotor 30 is attached to the fixed housing 20, the alignment recess 44a is fitted on the alignment protrusion 23 to allow the common rotor 30 to be set in a preset position. This configuration allows for mass production and reliable assembly.

In addition, the use of the blocking tumbler 44 can prevent a third party from locking or unlocking the locking device by easily separating the common rotor 30, thereby preventing the non-driving parts from being accessed.

Furthermore, according to the present disclosure, the shoulders 45 may be formed only on one side of the arc-shaped engagement portions 42 of the disk-shaped tumblers 40 and the blocking tumbler 44, such that the shoulders 45 are supported on top of the coil springs 50.

Seating recesses 35 are formed on both sides of the disk slots 31, and the coil springs 50 are disposed in the seating recesses 35. A passage 36 is formed in the portion connecting each pair of seating recesses 35. Consequently, when the disk-shaped tumblers 40 move up and down, the shoulders 45 are supported on the coil springs 50 while moving through the passages 36.

The disk-shaped tumblers 40 may be provided in a pair. The pair of disk-shaped tumblers 40 are stacked such that the shoulders 45 face in the opposite directions, and then are fitted into the disk slots 31 such that the shoulders 45 are supported on the corresponding coil springs 50.

In contrast, a single blocking tumbler 44 is fitted into the blocking slot 34 such that the blocking tumbler 44 is supported on a single coil spring 50 disposed in the seating recess 35 on one side.

Since the fitted blocking tumbler 44 is not repeatedly moved up and down differently from the disk-shaped tumblers 40, the single blocking tumbler is allowable. It is preferable that the blocking tumbler 44 have sufficient thickness to avoid being forcibly separated.

Consequently, the disk-shaped tumblers 40 having the same shape can be easily fitted into the disk slots 31 by setting the shoulders 45 to face in opposite directions, thereby improving the mass production and assembly efficiency of common locking devices 100.

In addition, the pair of stacked disk-shaped tumblers are fitted into the single disk slot 31, such that the shoulders 45 on both sides are reliably supported on the coil springs 50.

Thus, in the insertion of the individual keys 5 and 15 and the common key 200, when the projections 203 or the depressions 204 on any one side come into contact with the disengagement protrusions 43 on any one side, the pair of disk-shaped tumblers 40 are simultaneously moved downwardly.

Here, the shoulders 45 can be moved up and down while being reliably supported on the coil springs 50 to provide stability and reliability to the engagement and disengagement between the blocking grooves 21 and the engagement portions.

The locking and unlocking operations of the common locking device for a non-driving part of a working vehicle according to the present embodiment configured as above will be described with reference to FIG. 5a to FIG. 7.

First, as illustrated in FIG. 5a and FIG. 5b, in the locked position of the common locking device 100, the engagement portions 42 of the disk-shaped tumblers 40 are slightly engaged with the blocking grooves 21.

Thus, when an operator or an owner of the working vehicle inserts the individual keys 5 and 15 into the key-hole, the disk-shaped tumblers 40 slightly engaged with the blocking grooves 21 can be sufficiently moved downwardly, thereby allowing an unlocked position to be obtained. It is thereby possible to lock and unlock the common locking device 100 using the individual keys 5 and 15.

In addition, when a worker authorized for handling of the non-driving parts 3 and 13 of the working vehicles inserts the common key 200 into the common rotor 30, the projections 203 and the depressions 204 of the common key 200 can move the engagement portions 42 away from the position in which the engagement portions 42 are slightly engaged with the blocking grooves 21. The common key 200 can lock and unlock the common locking device 100, while it is impossible to lock or unlock the individual locking devices 4 and 14 using the common key 200.

When the common key 200 is fitted into the key-hole 32 as described above, as illustrated in FIG. 6a and FIG. 6b, the insertion guide grooves 202 of the common key 200 are matched with the guide protrusions 33, so that the common key 200 enters the key-hole 32 while the key channels 41 of the disk-shaped tumblers 40 guide the insertion of the common key 200.

Here, during the entrance, the inclined portion of the first projection 203 of the common key 200 comes into contact with the chamfered portions 43a of the disengagement protrusions 43. Consequently, the disk-shaped tumblers 40 are moved upwardly and downwardly as the projections 203 and the depressions 204 sequentially come into contact with the disk-shaped tumblers 40.

When the leading end of the blade 201 of the common key 200 has been inserted to reach the blocking tumbler 44, the disk-shaped tumblers 40 are in downwardly-moved positions, as illustrated in FIG. 6a.

Here, the disk-shaped tumblers 40 can be moved downwardly through engaging with the projections 203 or the depressions 204. The positions and sizes of the projections 203 and the depressions 204 of the common key 200 can be determined variously depending on the configurations of the projections 203 and the depressions 204.

Since the engagement portions 42 of the plurality of disk-shaped tumblers 40 are slightly engaged with the blocking grooves 21 as described above, when the engagement portions 42 of the disk-shaped tumblers 40 are moved slightly downwardly by the projections 203 or the depressions 204, the engagement portions 42 are easily disengaged from the blocking grooves 21, thereby allowing an unlocked position to be obtained.

Thereafter, the worker positions the engagement portion 42 to be ready to engage with a disengagement recess 25 formed in the inner circumference of the fixed housing 20 by rotating the common key 200 in one direction, as illustrated in FIG. 7, and then removes the common key 200. Then, the disk-shaped tumblers 40 are engaged with the disengagement recess 25 through being elastically pushed by the coil springs 50, thereby maintaining the unlocked position.

This also causes a locking lever 70 connected to a rod 37 of the common rotor 30 protruding out of the fixed housing 20 to rotate along with the common rotor 30, whereby the non-driving part is in the unlocked position.

When the common key 200 is inserted into the key-hole to return the non-driving parts 3 and 13 to the locked position, the disengagement protrusions 43 of the disk-shaped tumblers 40 are moved downwardly through contact with the projections 203 and the depressions 204 of the common key 200, and the engagement portions 42 are separated from the disengagement recess 25.

Thus, when the worker rotates the common key 200 and then removes the common key 200, the disk-shaped tumblers 40 are elastically pushed by the coil springs 50 to be engaged with the blocking grooves 21, whereby a locked position is maintained.

This also causes the locking lever 70 connected to the rod 37 of the common rotor 30 to rotate along with the common rotor 30 to maintain the non-driving part in the locked position.

According to the present disclosure as set forth above, the common locking devices 100 are provided in the non-driving parts 3 and 13 of the working vehicles 1 and 10. Even when the owners of the working vehicles 1 and 10 are absent, workers authorized for handling of the non-driving parts 3 and 13 can lock and unlock the non-driving parts 3 and 13 of the plurality of working vehicles using the common key 200 to perform required operations.

Although the specific exemplary embodiments of the present disclosure have been presented in the foregoing descriptions, many modifications and variations are obviously possible for a person skilled in the art without departing from the principle and scope of the present invention defined by the appended Claims and equivalents thereof.

### INDUSTRIAL APPLICABILITY

The common locking device for a non-driving part of a working vehicle according to the present disclosure improves assembly efficiency and mass production by simplifying the configuration of the tumbler array thereof. It is also possible to realize the common use of the locking devices for non-driving parts while maintaining the security function of the locking devices. Even when a plurality of working vehicles are operated, it is possible to repair and manage the plurality of working vehicles by efficiently managing the operations of locking and unlocking non-driving parts using common keys and common locking devices.

Therefore, manufacturers of working vehicles can more efficiently and systematically manage the maintenance of non-driving parts, thereby improving the quality of maintenance services. It is not necessary to carry several keys to unlock driving parts and non-driving parts of working vehicles. Furthermore, it is possible to efficiently classify and manage operators in charge of working vehicles and mechanics concerned with maintenance, thereby effectively preventing working vehicles from being stolen.

1. A common locking device comprising:
keys including common keys to be commonly used by persons concerned with non-driving parts of working vehicles not associated with driving of the working vehicles to lock or unlock the non-driving parts, each key comprising projections and depressions;
a fixed housing disposed in the non-driving part of each working vehicle, and having therein a rotation space, in an inner circumference of which a plurality of blocking grooves are formed;
a cylindrical common rotor rotatably disposed in the rotation space, and having a plurality of disk slots cut through the cylindrical common rotor in directions intersecting a direction in which each key is inserted and a pair of guide protrusions formed on inner wall portions of an entrance of an inner key-hole to guide insertion of each key; and
disk-shaped tumblers fitted into the disk slots to be elastically pushed in directions of the blocking grooves, wherein each of the disk-shaped tumblers comprises: a key channel formed in a central portion to have an opening on one side; a connecting portion on the opposite side forming an arc-shaped engagement portion, a radius of which is smaller than a radius of the rotation space; and a pair of disengagement protrusions formed on inner portions of the opening to face each other, wherein the projections and the depressions of each key are to come into contact with the disengagement protrusions,
wherein ends of the engagement portions are formed differently from each other to engage with the blocking grooves to such slight depths that the engagement portions can be disengaged from the blocking grooves by an outermost projection from among the projections, an innermost projection from among the projections and the depressions, allowing the common rotor to be unlocked using the common keys.

2. The common locking device of claim 1,
wherein the keys further comprise individual keys configured to lock and unlock both driving parts and the non-driving parts of the working vehicles,
wherein each of the individual keys and the common keys comprises a pair of insertion guide grooves in both side surfaces of a flat blade, the insertion guide grooves configured to receive the guide protrusions to guide insertion of each key, and
wherein the projections and depressions are formed below a first insertion guide groove in one side surface of the blade and above a second insertion guide groove in the other side surface of the blade, and when the blade is inserted, come into contact with the disengagement protrusions to move the tumblers, so that the engagement portions are separated from the blocking grooves, thereby allowing an unlocked position to be obtained.

3. The common locking device of claim 2,
wherein the first guide groove is formed to be downwardly offset from a centerline and the second guide groove is formed to be upwardly offset from the centerline, such that the second guide groove is offset from the first guide groove, and
wherein the guide protrusions of the common rotor comprise a first protrusion and a second protrusion formed in positions corresponding to the first guide groove and the second guide groove to exclude insertion of keys other than the individual keys and the common keys in which the same first guide groove and the same second guide groove are commonly formed.

4. The common locking device of claim 2, wherein the insertion guide grooves and the guide protrusions are diagonally offset with respect to the centerline at the same distance from the centerline, such that, when each of the individual keys and the common keys are inserted into the key-hole, orientation of each key is not restricted.

5. The common locking device of claim 1, wherein one disk slot from among the plurality of disk slots comprises a blocking slot, a fastening groove is formed in an inner circumference of the fixed housing to be parallel to the blocking grooves, and a blocking tumbler is disposed in the blocking slot, the blocking tumbler being elastically fitted into the fastening groove to prevent the common rotor from being separated.

6. The common locking device of claim 5, wherein the blocking tumbler has a same shape as the disk-shaped tumblers, with an alignment recess being formed in a central position of an arc-shaped engagement portion of the blocking tumbler, the fastening groove is formed along an entire circumference of the rotation space, and an alignment protrusion is disposed on an inner circumference of the fastening groove, the alignment recess being fitted on the alignment protrusion to set the common rotor in a predetermined position when the common rotor is attached to the fixed housing.

7. The common locking device of claim 1 or 5, wherein a shoulder is disposed on one side of the arc-shaped engagement portion of each of the disk-shaped tumblers and the blocking tumbler to be supported on top of a coil spring, and seating recesses are formed on both sides of each of the disk slots, the coil springs being disposed in the seating recesses, such that the shoulder is movable through a passage formed in a portion connecting the seating recesses.

8. The common locking device of claim 7, wherein the disk-shaped tumblers comprise a pair of disk-shaped tumblers stacked such that the shoulders face in opposite directions, the pair of stacked disk-shaped tumblers being fitted into the disk slot such that the shoulders are supported on the coil springs, respectively, and the blocking tumbler comprises a single blocking tumbler fitted into the blocking slot to be supported on the coil spring disposed in the seating recess on one side.

9. The common locking device of claim 5, wherein a shoulder is disposed on one side of the arc-shaped engagement portion of each of the disk-shaped tumblers and the blocking tumbler to be supported on top of a coil spring, and seating recesses are formed on both sides of each of the disk slots, the coil springs being disposed in the seating recesses, such that the shoulder is movable through a passage formed in a portion connecting the seating recesses.

10. The common locking device of claim 9, wherein the disk-shaped tumblers comprise a pair of disk-shaped tumblers stacked such that the shoulders face in opposite directions, the pair of stacked disk-shaped tumblers being fitted into the disk slot such that the shoulders are supported on the coil springs, respectively, and the blocking tumbler comprises a single blocking tumbler fitted into the blocking slot to be supported on the coil spring disposed in the seating recess on one side.
